(19) United States
(12) Patent Application Publication
(10) Pub. No.: US 2015/0296370 A1
(43) Pub. Date: Oct. 15, 2015

(54) OPERATION METHOD OF STATION BASED ON STATION DENSITY IN WIRELESS LOCAL AREA NETWORK

(71) Applicant: NEWRACOM, INC., Irvine, CA (US)

(72) Inventors: Hyoil KIM, Ulsan (KR); Minho CHEONG, Irvine, CA (US); Hyoung jin KWON, Daejeon (KR); Hong Soog KIM, Daejeon (KR)

(21) Appl. No.: 14/682,787

(22) Filed: Apr. 9, 2015

Related U.S. Application Data
(60) Provisional application No. 61/977,523, filed on Apr. 9, 2014.

(30) Foreign Application Priority Data
Apr. 8, 2015 (KR) 10-2015-0049394

(51) Int. Cl. H04W 8/18; H04W 24/08; H04W 84/12

(52) U.S. Cl. CPC H04W 8/183; H04W 84/12; H04W 24/08

(57) ABSTRACT

Disclosed are operation methods of station based on station density in wireless local area network. An operation method comprises obtaining density-related information indicating a station density state within a communication area of the first station; and transmitting a notification frame including at least one of an operation mode indication information and a clear channel assessment (CCA) threshold that are set based on the density-related information. Therefore, performance of WLAN can be enhanced.

### CLAIM FOR PRIORITY

This application claims priorities to U.S. Patent Application No. 61/977,523 filed on Apr. 9, 2014, and Korean Patent Application No. 10-2015-0049394 filed on Apr. 8, 2015, the entire contents of which are hereby incorporated by reference.

### BACKGROUND

1. Technical Field

The present invention relates to wireless local area network (WLAN) technologies, and more particularly, to operation methods of a station based on station density.

2. Related Art

With the development of information communication technologies, a variety of wireless communication technologies have been developed. Among these technologies, wireless local area network (WLAN) is a technology that Internet access is possible in a wireless way in homes, business or specific service providing areas, using portable terminal such as personal digital assistant (PDA), a laptop computer, a portable multimedia player (PMP), or the like, based on wireless frequency technologies.

WLAN technologies is created and standardized by the IEEE 802.11 Working Group under IEEE 802 Standard Committee. IEEE 802.11a provides a maximum PHY data rate of 54 Mbps using a 5 GHz unlicensed band. IEEE 802.11b provides a maximum PHY data rate of 11 Mbps by applying a direct sequence spread spectrum (DSSS) modulation at 2.4 GHz. IEEE 802.11g provides a maximum PHY data rate of 54 Mbps by applying orthogonal frequency division multiplexing (OFDM) at 2.4 GHz. IEEE 802.11n provides a PHY data rate of 300 Mbps using two spatial streams and bandwidth of 40 MHz, and provides a PHY data rate of 600 Mbps using four spatial streams and bandwidth of 40 MHz.

As such WLAN technology becomes more prevalent and its applications become more diverse, there is increasing demand for new WLAN technology that can support a higher throughput than IEEE 802.11n. Very high throughput (VHT) WLAN technology, that is one of the IEEE 802.11 WLAN technologies, is proposed to support a data rate of 1 Gbps and higher. IEEE 802.11ac has been developed as a standard for providing VHT in the 5 GHz band, and IEEE 802.11ad has been developed as a standard for providing VHT in the 60 GHz band.

In addition to the above-described standards, various standards on WLAN technologies have been developed, and are being developed. As representative recent technologies, a WLAN technology according to IEEE 802.11af standard is a technology which has been developed for WLAN operation in TV white space bands, and a WLAN technology according to IEEE 802.11ah standard is a technology which has been developed for supporting a great number of stations operating with low power in sub 1 GHz band, and a WLAN technology according to IEEE 802.11ai standard is a technology which has been developed for supporting fast initial link setup (FILS) in WLAN systems. Also, IEEE 802.11ax standard is being developed for enhancing frequency efficiency of dense environments in which numerous access points and stations exist.

In the system based on such the WLAN technologies (i.e., WLAN system), when a plurality of communication entities (i.e., access point, station, etc.) operate based on a fixed clear channel assessment (CCA) threshold in dense environment, arbitrary communication entity may not obtain transmit opportunity (TXOP) of a frame by communication performed on other communication entity. Therefore, there is problem that performance of the WLAN system is decreased.

### SUMMARY

The present invention is directed to providing a method and an apparatus for measuring station density state.

The present invention is also directed to providing a method and an apparatus for determining an operation mode based on station density state.

The present invention is also directed to providing a method and an apparatus for determining clear channel assessment (CCA) threshold based on station density state.

In order to achieve the objectives of the present invention, an operation method performed by a first station, the operation method comprises obtaining density-related information indicating a station density state within a communication area of the first station; and transmitting a notification frame including at least one of an operation mode indication information and a clear channel assessment (CCA) threshold that are set based on the density-related information.

Here, the obtaining of the density-related information comprises receiving a density report frame including the density-related information from a second station.

In addition, the obtaining of the density-related information comprises transmitting a density request frame that requests provision of the density-related information; and receiving a density response frame including the density-related information from a second station in response to the density request frame.

Here, the density-related information includes at least one of quality information related to transmission/reception of the first station and quality information related to transmission/reception of a station positioned within the communication area of the first station.

Here, the operation mode indication information indicates an operation mode corresponding to a density state higher than a predetermined density state when a value indicated by the density-related information is equal to or greater than a predetermined reference.

Here, the CCA threshold is determined as a value greater than a predetermined CCA threshold when a value indicated by the density-related information is equal to or greater than a predetermined reference.

Here, the CCA threshold is determined as a value equal to or less than a predetermined CCA threshold when a value indicated by the density-related information is less than a predetermined reference.

Here, the notification frame further includes an identifier indicating a station to which at least one of an operation mode indicated by the operation mode indication information and the CCA threshold is applied, a modulation and coding scheme (MCS) index of the station, or a sector number of a sector to which the station belongs.

Here, the identifier is an association identifier (AID), a partial AID (PAID), or a group ID.

Here, the notification frame further includes information regarding duration for which at least one of an operation mode indicated by the operation mode indication information and the CCA threshold is applied.

In order to achieve the objectives of the present invention, an operation method performed by a first station, the operation method comprises obtaining density-related information indicating a station density state within a communication area of the first station; and changing at least one of an operation mode and a CCA threshold of the first station based on the density-related information.

Here, the operation mode is changed to an operation mode corresponding to a density state higher than a predetermined density state when a value indicated by the density-related information is equal to or greater than a predetermined reference.

Here, the CCA threshold is changed to a value greater than a predetermined CCA threshold when a value indicated by the density-related information is equal to or greater than a predetermined reference.

Here, the CCA threshold is changed to a value equal to or less than a predetermined CCA threshold when a value indicated by the density-related information is less than a predetermined reference.

In order to achieve the objectives of the present invention, an operation method performed by a first station, the operation method comprises receiving a notification frame including at least one of an operation mode indication information and a clear channel assessment (CCA) threshold from a second station; and changing an operation mode of the first station based on an operation mode indicated by the received operation mode indication information or changing a CCA threshold of the first station based on the received CCA threshold.

In addition, the operation method further comprises transmitting a density report frame including density-related information indicating a station density state within a communication area of the second station to the second station.

In addition, the operation method further comprises receiving, from the second station, a density request frame that requests provision of the density-related information indicating the station density state within the communication area of the second station; and transmitting a density response frame including the density-related information to the second station in response to the density request frame.

Here, the notification frame further includes an identifier indicating the first station to which at least one of an operation mode indicated by the operation mode indication information and the CCA threshold is applied, a modulation and coding scheme (MCS) index of the first station, or a sector number of a sector to which the first station belongs.

Here, the identifier is an association identifier (AID), a partial AID (PAID), or a group ID.

Here, the notification frame further includes information regarding duration for which at least one of an operation mode indicated by the operation mode indication information and the CCA threshold is applied.

### BRIEF DESCRIPTION OF DRAWINGS

Example embodiments of the present invention will become more apparent by describing in detail example embodiments of the present invention with reference to the accompanying drawings, in which:

FIG. 1 is a block diagram illustrating a structure of a WLAN device;

FIG. 2 is a schematic block diagram illustrating a transmitting signal processor in a WLAN;

FIG. 3 is a schematic block diagram illustrating a receiving signal processing unit in the WLAN;

FIG. 4 is a timing diagram illustrating interframe space (IFS) relationships;

FIG. 5 is a timing drawing illustrating a CSMA (carrier sense multiple access)/CA (collision avoidance) based frame transmission procedure for avoiding collision between frames in a channel;

FIG. 6 is a sequence chart illustrating an operating method of a station;

FIG. 7 is a sequence chart illustrating an embodiment of a method of obtaining the density-related information;

FIG. 8 is a sequence chart illustrating another embodiment of a method of obtaining the density-related information;

FIG. 9 is a block diagram illustrating an information element include in each of the density report frame and the density response frame;

FIG. 10 is a block diagram illustrating the information element included in the density request frame;

FIG. 11 is a graph illustrating a CCA threshold for an MCS index according to an embodiment of the present invention; and

FIG. 12 is a block diagram illustrating the information element included in the notification frame.

### DESCRIPTION OF EXAMPLE EMBODIMENTS

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In a wireless local area network (WLAN), a basic service set (BSS) includes a plurality of WLAN devices. The WLAN device may include a medium access control (MAC) layer and a physical (PHY) layer according to IEEE (Institute of Electrical and Electronics Engineers) 802.11 standard. In the plurality of WLAN devices, at least one WLAN device may be an access point and the other WLAN devices may be non-AP stations (non-AP STAs). Alternatively, all the plurality of WLAN devices may be non-AP STAs in Ad-hoc networking. In general, the AP STA and the non-AP STA may be collectively called the STA. However, for easy description, only the non-AP STA may be called the STA.

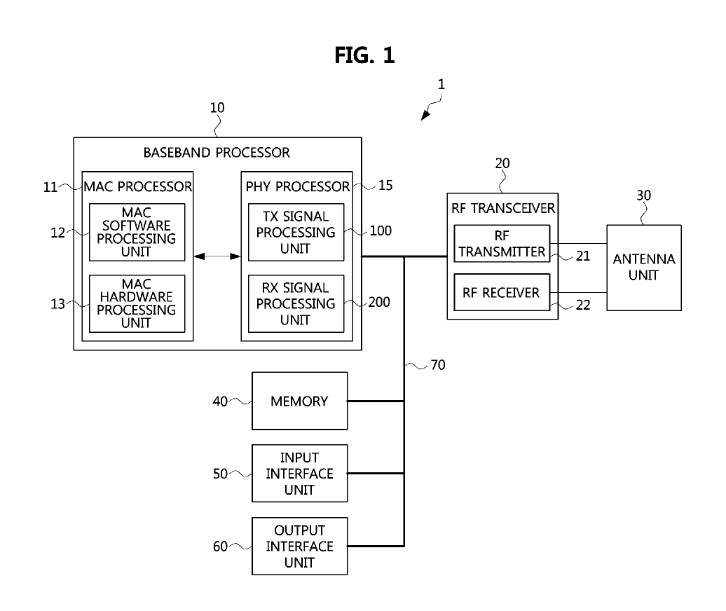

FIG. 1 is a block diagram illustrating a structure of a WLAN device.

Referring to FIG. 1, the WLAN device 1 may include a baseband processor 10, a radio frequency (RF) transceiver 20, an antenna unit 30, a memory 40, an input interface unit 50, an output interface unit 60, and a bus 70. The baseband processor 10 may perform baseband signal processing, and may include a MAC processor 11 and a PHY processor 15.

In one embodiment, the MAC processor 11 may include a MAC software processing unit 12 and a MAC hardware processing unit 13. The memory 40 may store software (hereinafter referred to as “MAC software”) including at least some functions of the MAC layer. The MAC software processing unit 12 executes the MAC software to implement the some functions of the MAC layer, and the MAC hardware processing unit 13 may implement remaining functions of the MAC layer as hardware (hereinafter referred to “MAC hardware”). However, the MAC processor 11 is not limited to this. The PHY processor 15 may include a transmitting signal processing unit 100 and a receiving signal processing unit 200.

The baseband processor 10, the memory 40, the input interface unit 50, and the output interface unit 60 may communicate with each other via the bus 70. The RF transceiver 20 may include an RF transmitter 21 and an RF receiver 22. The memory may further store an operating system and applications. The input interface unit 50 receives information from a user, and the output interface unit 60 outputs information to the user.

The antenna unit 30 includes one or more antennas. When multiple-input multiple-output (MIMO) or multi-user MIMO (MU-MIMO) is used, the antenna unit 30 may include a plurality of antennas.

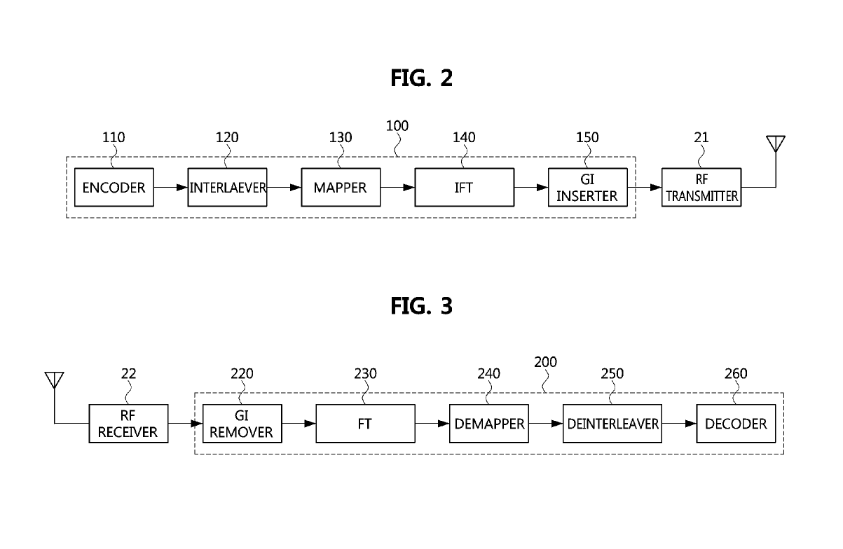

FIG. 2 is a schematic block diagram illustrating a transmitting signal processor in a WLAN.

Referring to FIG. 2, a transmitting signal processing unit 100 may include an encoder 110, an interlaever 120, a mapper 130, an inverse Fourier transformer (IFT) 140, and a guard interval (GI) inserter 150.

The encoder 110 encodes input data. For example, the encoder 100 may be a forward error correction (FEC) encoder. The FEC encoder may include a binary convolutional code (BCC) encoder followed by a puncturing device, or may include a low-density parity-check (LDPC) encoder.

The transmitting signal processing unit 100 may further include a scrambler for scrambling the input data before the encoding to reduce the probability of long sequences of 0s or 1s. If BCC encoding is used in the encoder, the transmitting signal processing unit 100 may further include an encoder parser for demultiplexing the scrambled bits among a plurality of BCC encoders. If LDPC encoding is used in the encoder, the transmitting signal processing unit 100 may not use the encoder parser.

The interleaver 120 interleaves the bits of each stream output from the encoder to change order of bits. Interleaving may be applied only when BCC encoding is used. The mapper 130 maps the sequence of bits output from the interleaver to constellation points. If the LDPC encoding is used in the encoder, the mapper 130 may further perform LDPC tone mapping besides the constellation mapping.

When the MIMO or the MU-MIMO is used, the transmitting signal processing unit 100 may use a plurality of interleavers 120 and a plurality of mappers corresponding to the number of NSS of spatial streams. In this case, the transmitting signal processing unit 100 may further include a stream parser for dividing outputs of the BCC encoders or the LDPC encoder into blocks that are sent to different interleavers 120 or mappers 130. The transmitting signal processing unit 100 may further include a space-time block code (STBC) encoder for spreading the constellation points from the NSS spatial streams into NSTS space-time streams and a spatial mapper for mapping the space-time streams to transmit chains. The spatial mapper may use direct mapping, spatial expansion, or beamforming

The IFT 140 converts a block of the constellation points output from the mapper 130 or the spatial mapper to a time domain block (i.e., a symbol) by using an inverse discrete Fourier transform (IDFT) or an inverse fast Fourier transform (IFFT). If the STBC encoder and the spatial mapper are used, the inverse Fourier transformer 140 may be provided for each transmit chain.

When the MIMO or the MU-MIMO is used, the transmitting signal processing unit 100 may insert cyclic shift diversities (CSDs) to prevent unintentional beamforming The CSD insertion may occur before or after the inverse Fourier transform. The CSD may be specified per transmit chain or may be specified per space-time stream. Alternatively, the CSD may be applied as a part of the spatial mapper. When the MU-MIMO is used, some blocks before the spatial mapper may be provided for each user.

The GI inserter 150 prepends a GI to the symbol. The transmitting signal processing unit 100 may optionally perform windowing to smooth edges of each symbol after inserting the GI. The RF transmitter 21 converts the symbols into an RF signal and transmits the RF signal via the antenna unit 30. When the MIMO or the MU-MIMO is used, the GI inserter 150 and the RF transmitter 21 may be provided for each transmit chain.

FIG. 3 is a schematic block diagram illustrating a receiving signal processing unit in the WLAN.

Referring to FIG. 3, a receiving signal processing unit 200 may include a GI remover 220, a Fourier transformer (FT) 230, a demapper 240, a deinterleaver 250, and a decoder 260. An RF receiver 22 receives an RF signal via the antenna unit 30 and converts the RF signal into the symbols. The GI remover 220 removes the GI from the symbol. When the MIMO or the MU-MIMO is used, the RF receiver 22 and the GI remover 220 may be provided for each receive chain.

The FT 230 converts the symbol (i.e., the time domain block) into a block of the constellation points by using a discrete Fourier transform (DFT) or a fast Fourier transform (FFT). The Fourier transformer 230 may be provided for each receive chain. When the MIMO or the MU-MIMO is used, the receiving signal processing unit 200 may a spatial demapper for converting the Fourier transformed receiver chains to constellation points of the space-time streams, and an STBC decoder for despreading the constellation points from the space-time streams into the spatial streams.

The demapper 240 demaps the constellation points output from the Fourier transformer 230 or the STBC decoder to the bit streams. If the LDPC encoding is used, the demapper 240 may further perform LDPC tone demapping before the constellation demapping. The deinterleaver 250 deinterleaves the bits of each stream output from the demapper 240. Deinterleaving may be applied only when BCC encoding is used.

When the MIMO or the MU-MIMO is used, the receiving signal processing unit 200 may use a plurality of demappers 240 and a plurality of deinterleavers 250 corresponding to the number of spatial streams. In this case, the receiving signal processing unit 200 may further include a stream deparser for combining the streams output from the deinterleavers 250.

The decoder 260 decodes the streams output from the deinterleaver 250 or the stream deparser. For example, the decoder 100 may be an FEC decoder. The FEC decoder may include a BCC decoder or an LDPC decoder. The receiving signal processing unit 200 may further include a descrambler for descrambling the decoded data. If BCC decoding is used in the decoder, the receiving signal processing unit 200 may further include an encoder deparser for multiplexing the data decoded by a plurality of BCC decoders. If LDPC decoding is used in the decoder 260, the receiving signal processing unit 100 may not use the encoder deparser.

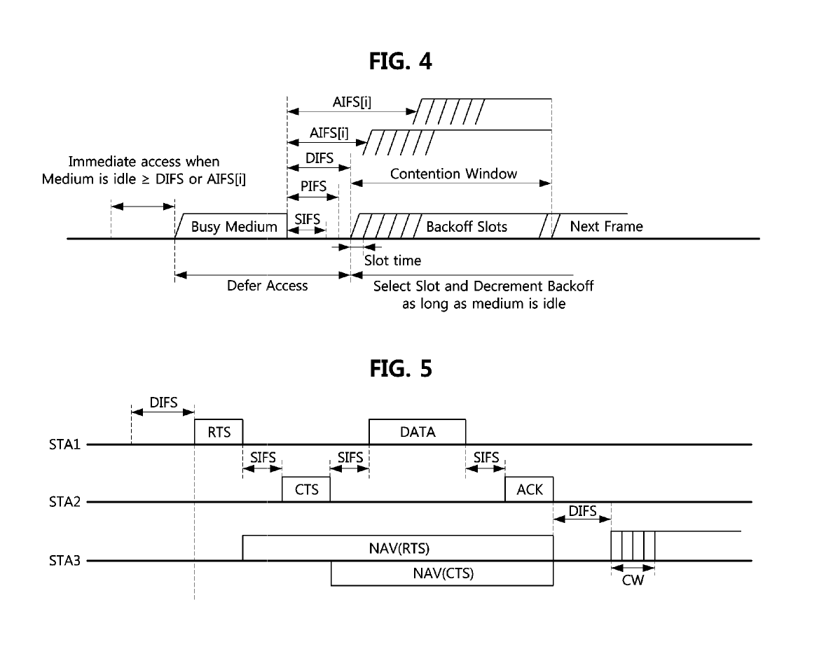

FIG. 4 is a timing diagram illustrating interframe space (IFS) relationships.

Referring to FIG. 4, a data frame, a control frame, or a management frame may be exchanged between WLAN devices. The data frame is used for transmission of data forwarded to a higher layer. The WLAN device transmits the data frame after performing backoff if a distributed coordination function IFS (DIFS) has elapsed from a time when the medium has been idle.

The management frame is used for exchanging management information which is not forwarded to the higher layer. Subtype frames of the management frame include a beacon frame, an association request/response frame, a probe request/response frame, and an authentication request/response frame. The control frame is used for controlling access to the medium. Subtype frames of the control frame include a request to send (RTS) frame, a clear to send (CTS) frame, and an acknowledgement (ACK) frame. In the case that the control frame is not a response frame of the other frame, the WLAN device transmits the control frame after performing backoff if the DIFS has elapsed. In the case that the control frame is the response frame of the other frame, the WLAN device transmits the control frame without performing backoff if a short IFS (SIFS) has elapsed. The type and subtype of frame may be identified by a type field and a subtype field in a frame control field.

On the other hand, a Quality of Service (QoS) STA may transmit the frame after performing backoff if an arbitration IFS (AIFS) for access category (AC), i.e., AIFS[AC] has elapsed. In this case, the data frame, the management frame, or the control frame which is not the response frame may use the AIFC[AC].

FIG. 5 is a timing drawing illustrating a CSMA (carrier sense multiple access)/CA (collision avoidance) based frame transmission procedure for avoiding collision between frames in a channel.

Referring to FIG. 5, STA1 is a transmit WLAN device for transmitting data, STA2 is a receive WLAN device for receiving the data, and STA3 is a WLAN device which may be located at an area where a frame transmitted from the STA1 and/or a frame transmitted from the STA2 can be received by the WLAN device.

The STA1 may determine whether the channel is busy by carrier sensing. The STA1 may determine the channel occupation based on an energy level on the channel or correlation of signals in the channel, or may determine the channel occupation by using a network allocation vector (NAV) timer.

When determining that the channel is not used by other devices during DIFS (that is, the channel is idle), the STA1 may transmit an RTS frame to the STA2 after performing backoff. Upon receiving the RTS frame, the STA2 may transmit a CTS frame as a response of the CTS frame after SIFS.

When the STA3 receives the RTS frame, it may set the NAV timer for a transmission duration of subsequently transmitted frames (for example, a duration of SIFS+CTS frame duration+SIFS+data frame duration+SIFS+ACK frame duration) by using duration information included in the RTS frame. When the STA3 receives the CTS frame, it may set the NAV timer for a transmission duration of subsequently transmitted frames (for example, a duration of SIFS+data frame duration+SIFS+ACK frame duration) by using duration information included in the RTS frame. Upon receiving a new frame before the NAV timer expires, the STA3 may update the NAV timer by using duration information included in the new frame. The STA3 does not attempt to access the channel until the NAV timer expires.

When the STA1 receives the CTS frame from the STA2, it may transmit a data frame to the STA2 after SIFS elapses from a time when the CTS frame has been completely received. Upon successfully receiving the data frame, the STA2 may transmit an ACK frame as a response of the data frame after SIFS elapses.

When the NAV timer expires, the STA3 may determine whether the channel is busy by the carrier sensing. Upon determining that the channel is not used by the other devices during DIFS after the NAV timer has expired, the STA3 may attempt the channel access after a contention window according to random backoff elapses.

On the other hand, a method of determining the occupied state of the channel may be classified into a physical carrier sensing method and a virtual carrier sensing method. A clear channel assessment (CCA) operating method may be used as the physical carrier sensing method. The CCA operating method may be classified into an energy detection (ED)-based CCA operating method and a carrier sensing (CS)-based CCA operating method. In the ED-based CCA operating method, a station that performs a CCA operation may determine that a corresponding channel is in a busy state when a signal having radio frequency (RF) energy equal to or greater than a CCA threshold at the probability of 90% or greater is sensed during aCCATime (e.g., 4 μs or lower) or when a signal having RF energy at least 20 dB greater than the CCA threshold is sensed. In the CS-based CCA operating method, the station that performs a CCA operation may determine that a corresponding channel is in a busy state when a physical layer convergence procedure (PLCP) preamble is sensed during aCCATme.

When the channel is determined to be in a busy state through the CCA operating method, a station may suspend transmitting a frame. When the channel is determined to be in an idle state through the CCA operating method, the station may perform a random back-off procedure when the channel is in an idle state during DIFS. That is, the station may randomly select a back-off time within the CW, and transmit a frame when the channel is in an idle state during the back-off time.

Next, a method of measuring a station density state within a communication area of arbitrary station, a method of determining an operation mode and a CCA threshold based on the measured station density state, a method of notifying the determined operation mode and CCA threshold, and an operating method based on the determined operation mode and CCA threshold will be described below. The methods may be performed by a WLAN device that has been described with reference to FIGS. 1 to 3.

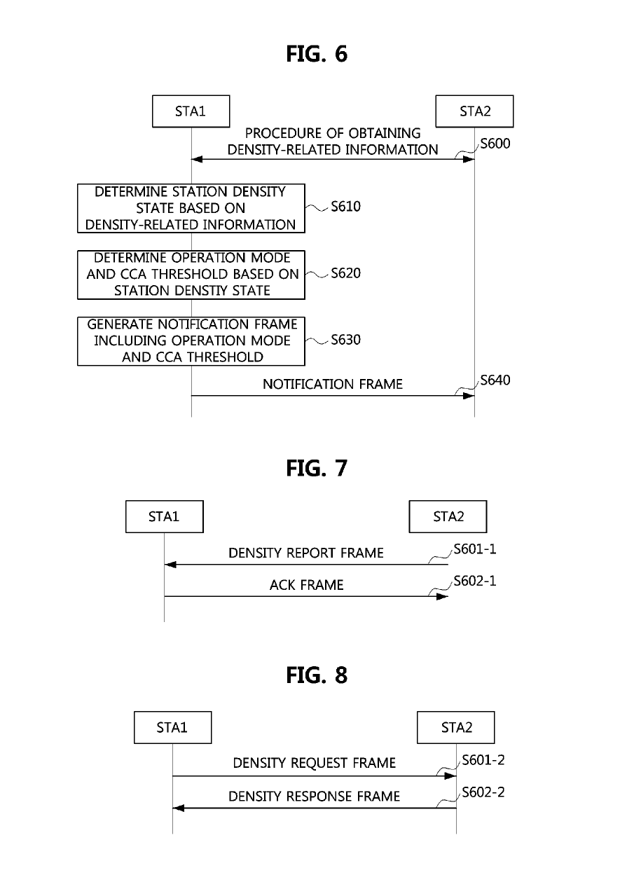

FIG. 6 is a sequence chart illustrating an operating method of a station.

Referring to FIG. 6, each of STA1 and STA2 may denote an AP or non-AP STA. When STA1 is an AP, STA2 may denote a non-AP STA associated with STA1, an AP (hereinafter referred to as “OBSS AP”) or a non-AP STA (hereinafter referred to as “OBSS STA”) belonging to a BSS that overlaps a BSS of STA1.

STA1 may periodically or aperiodically obtain density-related information indicating a station density state within its own communication area. The communication area of STA1 may denote an area in which the BSS of STA1 overlaps another BSS, an area of each of a plurality of sectors that are supported by STA1, an area that is beamformed by STA1, an area identified by a modulation and coding scheme (MCS) index (e.g., an area closer to STA1 as the MCS index increases), or the like. The station density state may be classified into a high density state and a low density state. The station density state is not limited to the classification and may be classified in various ways. For example, the station density state may be classified into a first density state, a second density state, a third density state, a fourth density state, and a fifth density state.

The density-related information may denote information used to estimate the station density state. For example, the information used to estimate the station density state may include at least one of quality information related to transmission or reception of STA1 and quality information related to transmission or reception of a station positioned within a communication range of STA1. Here, the quality information may denote a packet error rate, a throughput, a data rate, a signal to noise ratio (SNR), a signal to interference plus noise ratio (SINR), a noise floor (i.e., a value detected through energy detection (ED)), a path loss, and so on.

In addition, the information used to estimate the station density state may further include the number of stations (i.e., APs or non-AP STAs) per unit area within the communication area of STA1, the number of APs, the number of non-STAs, the number of non-AP STAs associated with STA1, the number of non-AP STAs that are in an awake state among the non-AP STAs associated with STA1, the number of non-AP STAs included in each of a plurality of sectors that are supported by STA1, the number of non-AP STAs that perform beamforming transmission with STA1, the number of non-AP STAs that do not perform beamforming transmission with STA1, a frequency of beamforming transmissions of STA1, the number of stations belonging to a BSS that overlaps a BSS of STA1, the number of OBSS APs, the number of OBSS STAs, and so on.

In addition, the density-related information may denote an index indicating the station density state. For example, when the station density state is determined to be higher (i.e., in a high density state) than a predetermined density state (i.e., a reference density state) by the information used to estimate the station density state, the index may be set to be “1.” On the contrary, when the station density state is not determined to be higher than the predetermined density state by the information used to estimate the station density state, the index may be set to be “0.”

On the other hand, STA1 may obtain the density-related information independently and may obtain the density-related information through a neighboring station. When the neighboring station is the non-AP STA associated with STA1, STA1 may obtain the density-related information based on the following scheme.

FIG. 7 is a sequence chart illustrating an embodiment of a method of obtaining the density-related information.

Referring to FIG. 7, STA1 and STA2 may be the same as STA1 and STA2 that are illustrated in FIG. 6, respectively. STA2 may obtain the density-related information independently and may obtain the density-related information through a neighboring station. For example, STA2 may obtain the density-related information by overhearing a frame including the density-related information that is transmitted from at least one of an OBSS AP and an OBSS STA. STA2 may generate a density report frame that includes the obtained density-related information and may periodically or aperiodically (e.g., when the density-related information is changed) transmit the generated density report frame (S601-1). In this case, when the channel is in an idle state during DIFS, STA2 may transmit the density report frame in a unicast scheme, a multicast scheme, or a broadcast scheme after the CW caused by a random back-off procedure. Upon receiving the density report frame from STA2, STA1 may transmit an ACK frame to STA2 after SIFS from an end point of the density report frame (S602-1). Here, the transmission of the ACK frame, which is a response to the density report frame, may be omitted.

FIG. 8 is a sequence chart illustrating another embodiment of a method of obtaining the density-related information.

Referring to FIG. 8, STA1 and STA2 may be the same as STA1 and STA2 that are illustrated in FIG. 7, respectively. STA1 may generate a density request frame that requests provision of the density-related information and may periodically or aperiodically transmit the generated density request frame (S601-2). In this case, when the channel is in an idle state during DIFS, STA1 may transmit the density request frame in a unicast scheme, a multicast scheme, or a broadcast scheme after the CW caused by a random back-off procedure. Upon receiving the density request frame from STA1, STA2 may identify that provision of the density-related information is requested. Accordingly, STA2 may generate a density response frame that includes the density-related information and may transmit the generated density response frame to STA1 after SIFS from an end point of the density request frame (S602-2).

Here, the density repot frame and the density response frame may have the same frame structure. One frame of the management frame, the control frame, and the data frame that are defined in IEEE 802.11 may be used for the density report frame and the density response frame. Here, a new frame for the density repot frame and the density response frame may be defined. An information element (IE) included in each of the density report frame and the density response frame may be as follows.

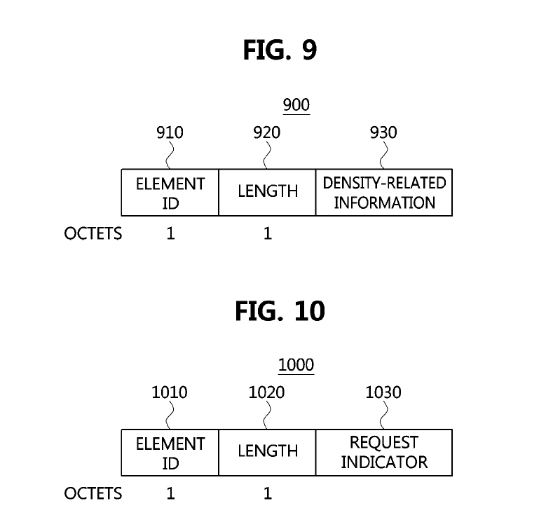

FIG. 9 is a block diagram illustrating an information element include in each of the density report frame and the density response frame.

Referring to FIG. 9, an information element 900 may include an element ID field 910 having a size of 1 octet, a length field 920 having a size of 1 octet, and a density-related information field 930. The density-related information field 930 may include at least one of the information used to estimate the station density state and the index indicating the station density state.

One frame (e.g., a beacon frame) of the management frame, the control frame, and the data frame that are defined in IEEE 802.11 may be used for the density request frame. In addition, a new frame for the density request frame may be defined. An information element (IE) included in the density request frame may be as follows.

FIG. 10 is a block diagram illustrating the information element included in the density request frame.

Referring to FIG. 10, an information element 1000 may include an element ID field 1010 having a size of 1 octet, a length field 1020 having a size of 1 octet, and a request indicator field 1030. The request indicator field 1030 may include an indicator that requests provision of the density-related information.

Referring again to FIG. 6, STA1 may obtain the density-related information from at least one of an OBSS AP and an OBSS STA. Here, STA1 may perform a procedure of obtaining density-related information of an associated non-AP STA and a procedure of obtaining density-related information of an OBSS station (i.e., an OBSS AP or OBSS STA) individually. When STA1 is associated with the OBSS AP by wire or wirelessly, STA1 may obtain the density-related information directly from the OBSS AP. In addition, when there is a controller that controls STA1 and the OBSS AP, STA1 may obtain the density-related information of the OBSS AP through the controller. Moreover, STA1 may obtain the density-related information by overhearing a frame including the density-related information that is transmitted from at least one of the OBSS AP and the OBSS STA.

Next, STA1 may periodically or aperiodically (e.g., when the density-related information is changed) notify the obtained density-related information. For example, STA1 may generate the density report frame including the density-related information similarly to the method that has been described with reference to FIG. 7 and may transmit the generated density report frame to notify the density-related information. Here, the beacon frame may be used as the density report frame. In this case, when the channel is in an idle state during DIFS, STA1 may transmit the density report frame in a unicast scheme, a multicast scheme, or a broadcast scheme after the CW caused by a random back-off procedure. Upon receiving the density report frame, STA2 may transmit an ACK frame to STA1 after SIFS from an end point of the density report frame. Here, the transmission of the ACK frame, which is a response to the density report frame, may be omitted.

STA1 may determine a station density state within its own communication area based on the density-related information (S610). On a condition that the density-related information includes the information used to estimate the station density, STA1 may estimate the station density state as being higher than a predetermined density state (e.g., a high density state) when each piece of information (i.e., a packet error rate, a noise floor, the number of non-AP STAs associated with STA1, etc.) included in the density-related information or an average of each piece of the information is equal to or greater than a predetermined reference; otherwise, the station density state may be estimated not to be higher than the predetermined density state.

Alternatively, STA1 may estimate the station density state as being higher than a predetermined density state (e.g., a high density state) when each piece of information (i.e., a transmission rate, a data rate, an SNR, an SINR, etc.) included in the density-related information or an average of each piece of the information is less than a predetermined reference; otherwise, the station density state may be estimated not to be higher than the predetermined density state.

Alternatively, STA1 may estimate the station density state as being higher than a predetermined density state when the number of pieces of information that satisfy the aforementioned references is equal to or greater than a threshold value; otherwise, the station density state may be estimated not to be higher than the predetermined density state.

On a condition that the density-related information includes an index indicating the station density state, STA1 may estimate the station density state as being higher than a predetermined density state when the number of frames including an index indicating that the station density state is higher than a predetermined density state is equal to or greater than a predetermined reference; otherwise, the station density state may be estimated not to be higher than the predetermined density state.

STA1 may determine at least one of an operation mode and a CCA threshold based on the density-related information or the station density state (S620). The operation mode may be classified into a high-density operation mode and a low-density operation mode. The operation mode is not limited to the classification and may be classified in various ways. For example, the operation mode may be classified into a first operation mode, a second operation mode, a third operation mode, a fourth operation mode, and a fifth operation mode. Here, each of the determined operation mode and CCA threshold may be used by at least one of STA1 and a station indicated by a notification frame that will be described later.

STA1 may determine the operation mode as an operation mode corresponding to a high density state (e.g., a high-density operation mode) when the aforementioned density-related information satisfies the predetermined reference or when the station density state is determined as being higher than the predetermined density state; otherwise, STA1 may not determine the operation mode as the operation mode corresponding to the high density state. In addition, STA1 may determine the CCA threshold as a value greater than a predetermined CCA threshold (e.g., a default value of the CCA threshold) when the aforementioned density-related information satisfies the predetermined reference or when the station density state is determined as being higher than the predetermined density state; otherwise, STA1 may determine the CCA threshold as a value equal to or less than the predetermined CCA threshold. In this case, the default value of the CCA threshold may denote a value defined in standards prior to IEEE 802.11ax. For example, the default value of the CCA threshold may be −82 dB. In addition, the default value of the CCA threshold may denote a value newly defined in IEEE 802.11ax.

Here, STA1 may determine at least one of the operation mode and the CCA threshold for each of a downlink and an uplink independently and may determine at least one of the operation mode and the CCA threshold for each of a station and a group of stations. For example, STA1 may determine the CCA threshold for a station group having a specific MCS index.

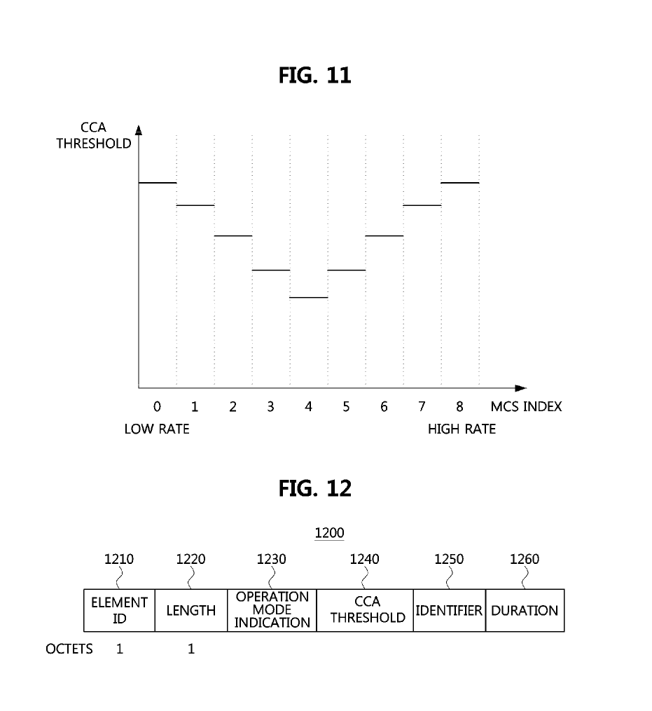

FIG. 11 is a graph illustrating a CCA threshold for an MCS index according to an embodiment of the present invention.

Referring to FIG. 11, a non-AP STA having a relatively high MCS index may be estimated to be positioned in an area close to STA1 while a non-AP STA having a relatively low MCS index may be estimated to be positioned in an area far from STA1. That is, a non-AP STA having an MCS index of 8 may be estimated to be positioned in an area closest to STA1 while a non-AP STA having an MCS index of 0 may be estimated to be positioned in an area farthest from STA1.

STA1 may determine the CCA threshold differently depending on the MCS index. For example, STA1 may determine the CCA threshold to be a largest value when the MCS index is 0 or 8 and may determine the CCA threshold to be a smallest value when the MCS index is 4.

Referring again to FIG. 6, STA1 may generate a notification frame including at least one of operation mode indication information and the CCA threshold (S630). The notification frame may further include an identifier indicating a station to which at least one of an operation mode indicated by the operation mode indication information and the CCA threshold is applied. The identifier may denote an association identifier (AID), a partial AID (PAID), a group ID, or the like. The notification frame may include an MCS index of the station to which at least one of the operation mode and the CCA threshold is applied or a sector number of a sector to which the station belongs, instead of the identifier. In addition, the notification frame may further include information regarding duration for which at least one of the operation mode and the CCA threshold is applied. One frame (e.g., a beacon frame) of the management frame, the control frame, and the data frame that are defined in IEEE 802.11 may be used for the notification frame. In addition, a new frame for the notification frame may be defined. An information element (IE) included in the notification frame may be as follows.

FIG. 12 is a block diagram illustrating the information element included in the notification frame.

Referring to FIG. 12, a notification frame 1200 may include an element ID field 1210 having a size of 1 octet, a length field 1220 having a size of 1 octet, an operation mode indication field 1230, a CCA threshold field 1240, an identifier field 1250, and a duration field 1260. The operation mode indication field 1230 may indicate an operation mode determined by STA1 (e.g., a high-density operation mode, a low-density operation mode, etc.) Alternatively, the operation mode indication field 1230 may indicate a station density state determined by STA1 (e.g., a high-density state, a low-density state, etc.), instead of the operation mode. The CCA threshold field 1240 may include a CCA threshold determined by STA1. When the CCA threshold field determined by STA1 is a default value, the notification frame 1200 may not include the CCA threshold field 1240.

The identifier field 1250 may include an identifier indicating a station to which at least one of the operation mode indicated by the operation mode indication field 1230 and the CCA threshold indicated by the CCA threshold field 1240 is applied, an MCS index of the station, or a sector number of a sector to which the station belongs. When at least one of the operation mode indicated by the operation mode indication field 1230 and the CCA threshold indicated by the CCA threshold field 1240 is applied to all stations, the notification frame 1200 may not include the identifier field 1250.

The duration field 1260 may include information regarding duration for which at least one of the operation mode indicated by the operation mode indication field 1230 and the CCA threshold indicated by the CCA threshold field 1240 is applied. When at least one of the operation mode indicated by the operation mode indication field 1230 and the CCA threshold indicated by the CCA threshold field 1240 keeps being applied, the notification frame 1200 may not include the duration field 1260.

Referring again to FIG. 6, STA1 may periodically or aperiodically (e.g., when at least one of the operation mode and the CCA threshold is changed) transmit the notification frame (S640). In this case, when the channel is in an idle state during DIFS, STA1 may transmit the notification frame in a unicast scheme, a multicast scheme, or a broadcast scheme after the CW caused by a random back-off procedure. Upon receiving the notification frame, STA2 may transmit an ACK frame to STA1 after SIFS from an end point of the notification. Here, the transmission of the ACK frame, which is a response to the density report frame, may be omitted.

STA2 may operate based on at least one of the operation mode indicated by an operation mode indication field and the CCA threshold indicated by the CCA threshold field, which are included in the notification frame, when its identifier is the same as the identifier indicated by the identifier field included in the notification frame, when its MCS index is the same as the MCS index indicated by the identifier field included in the notification frame, or when its sector number is the same as the sector number indicated by the identifier field included in the notification frame. STA2 may determine a station density state within a communication area of STA1 as being higher than a predetermined density state when the operation mode indication field included in the notification frame indicates an operation mode corresponding to a density state higher than the predetermined density state, and thus may operate based on the operation mode indicated by the operation mode indication field (e.g., change its CCA threshold to a value greater than a predetermined threshold, set a CW caused by a random back-off procedure to be short, search for an adjacent AP, etc.)

In addition, STA2 may change its CCA threshold to the CCA threshold indicated by the CCA threshold field included in the notification frame and transmit a frame based on a CCA operation according to the changed CCA threshold. In this case, STA2 may transmits a frame based on a CCA operation according to the changed CCA threshold for duration indicated by the duration filed included in the notification frame. For example, when the station density state is higher than the predetermined density state, the CCA threshold indicated by the CCA threshold field included in the notification frame is greater than the predetermined CCA threshold. Thus STA2 may transmit a frame based on a CCA operation according to the CCA threshold greater than the predetermined CCA threshold. Alternatively, when the station density state is not higher than the predetermined density state, the CCA threshold indicated by the CCA threshold field included in the notification frame is equal to or less than the predetermined CCA threshold. Thus STA2 may transmit a frame based on a CCA operation according to the CCA threshold equal to or less than the predetermined CCA threshold.

STA1 may generate the notification frame including the CCA threshold field that is set as the predetermined CCA threshold and transmit the generated notification frame when at least one of quality information related to transmission/reception of STA1 and quality information related to transmission/reception of a station positioned within the communication area of STA1 is not enhanced even by the CCA threshold greater than the predetermined CCA threshold.

On the other hand, when the operation mode is changed, STA1 may operate based on the changed operation mode (e.g., change a CCA threshold of STA1). When the CCA threshold is changed (e.g., when the CCA threshold of STA1 is change more than a CCA threshold of a station associated with STA1), STA1 may perform a CCA operation according to the changed CCA threshold. Upon overhearing a notification frame transmitted from an OBSS station (i.e., an OBSS AP or OBSS STA), each of STA1 and STA2 may identify a station density state within a communication area of the OBSS station. Similarly, upon overhearing a notification frame transmitted from STA1, the OBSS station (i.e., an OBSS AP or OBSS STA) may identify the station density state within the communication area of STA1.

A non-AP STA may initialize the operation mode and the CCA threshold when an AP associated through an association procedure, a disassociation procedure, and a reassociation procedure is changed. In addition, the non-AP STA may initialize the operation mode and the CCA threshold when the non-AP STA is transitioned from a sleep state to an awake state occurs. When an AP identifies the non-AP STA transitioned from the sleep state to the awake state, the AP may set at least one of the operation mode and the CCA threshold for the non-AP STA and may transmit a notification frame including at least one of the operation mode and the CCA threshold to the non-AP STA.

According to an embodiment of the present invention, the station can determine at least one of the operation mode and the CCA threshold based on at least one of the density-related information and the station density state estimated based on the density-related information. Thus, the station can obtain a frame transmission opportunity in a high-density area and minimize interference. Accordingly, the transmission rate per unit area can be enhanced, and also fairness between BSSs can be secured. That is, an average data rate and a sentiment quality of a user may be enhanced. Furthermore, a WLAN system can be operated according to the operation mode and the CCA threshold that are determined by an environment or policy of an operator.

While the example embodiments of the present invention and their advantages have been described in detail, it should be understood that various changes, substitutions and alterations may be made herein without departing from the scope of the invention.

What is claimed is:

1. An operation method performed by a first station, the operation method comprising:
obtaining density-related information indicating a station density state within a communication area of the first station; and
transmitting a notification frame including at least one of an operation mode indication information and a clear channel assessment (CCA) threshold that are set based on the density-related information.

2. The operation method of claim 1, wherein the obtaining of the density-related information comprises receiving a density report frame including the density-related information from a second station.

3. The operation method of claim 1, wherein the obtaining of the density-related information comprises:
transmitting a density request frame that requests provision of the density-related information; and
receiving a density response frame including the density-related information from a second station in response to the density request frame.

4. The operation method of claim 1, wherein the density-related information includes at least one of quality information related to transmission/reception of the first station and quality information related to transmission/reception of a station positioned within the communication area of the first station.

5. The operation method of claim 1, wherein the operation mode indication information indicates an operation mode corresponding to a density state higher than a predetermined density state when a value indicated by the density-related information is equal to or greater than a predetermined reference.

6. The operation method of claim 1, wherein the CCA threshold is determined as a value greater than a predetermined CCA threshold when a value indicated by the density-related information is equal to or greater than a predetermined reference.

7. The operation method of claim 1, wherein the CCA threshold is determined as a value equal to or less than a predetermined CCA threshold when a value indicated by the density-related information is less than a predetermined reference.

8. The operation method of claim 1, wherein the notification frame further includes an identifier indicating a station to which at least one of an operation mode indicated by the operation mode indication information and the CCA threshold is applied, a modulation and coding scheme (MCS) index of the station, or a sector number of a sector to which the station belongs.

9. The operation method of claim 8, wherein the identifier is an association identifier (AID), a partial AID (PAID), or a group ID.

10. The operation method of claim 1, wherein the notification frame further includes information regarding duration for which at least one of an operation mode indicated by the operation mode indication information and the CCA threshold is applied.

11. An operation method performed by a first station, the operation method comprising:
obtaining density-related information indicating a station density state within a communication area of the first station; and
changing at least one of an operation mode and a CCA threshold of the first station based on the density-related information.

12. The operation method of claim 11, wherein the operation mode is changed to an operation mode corresponding to a density state higher than a predetermined density state when a value indicated by the density-related information is equal to or greater than a predetermined reference.

13. The operation method of claim 11, wherein the CCA threshold is changed to a value greater than a predetermined CCA threshold when a value indicated by the density-related information is equal to or greater than a predetermined reference.

14. The operation method of claim 11, wherein the CCA threshold is changed to a value equal to or less than a predetermined CCA threshold when a value indicated by the density-related information is less than a predetermined reference.

15. An operation method performed by a first station, the operation method comprising:
receiving a notification frame including at least one of an operation mode indication information and a clear channel assessment (CCA) threshold from a second station; and
changing an operation mode of the first station based on an operation mode indicated by the received operation mode indication information or changing a CCA threshold of the first station based on the received CCA threshold.

16. The operation mode of claim 15, further comprising transmitting a density report frame including density-related information indicating a station density state within a communication area of the second station to the second station.

17. The operation method of claim 15, further comprising:
receiving, from the second station, a density request frame that requests provision of the density-related information indicating the station density state within the communication area of the second station; and
transmitting a density response frame including the density-related information to the second station in response to the density request frame.

18. The operation method of claim 15, wherein the notification frame further includes an identifier indicating the first station to which at least one of an operation mode indicated by the operation mode indication information and the CCA threshold is applied, a modulation and coding scheme (MCS) index of the first station, or a sector number of a sector to which the first station belongs.

19. The operation method of claim 18, wherein the identifier is an association identifier (AID), a partial AID (PAID), or a group ID.

20. The operation method of claim 15, wherein the notification frame further includes information regarding duration for which at least one of an operation mode indicated by the operation mode indication information and the CCA threshold is applied.
